(19) United States
(12) Patent Application Publication
(10) Pub. No.: US 2007/0237110 A1
(43) Pub. Date: Oct. 11, 2007

(54) NETWORK NODES EXCHANGING ADDRESSES AND DETACHMENT INFORMATION TO SUPPORT DETACHMENT

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/751,002

(22) Filed: May 19, 2007

Related U.S. Application Data
(63) Continuation-in-part of application No. 11/365,102, filed on Mar. 1, 2006.
(63) Continuation-in-part of application No. 11/394,253, filed on Mar. 30, 2006.
(63) Continuation-in-part of application No. 11/418,644, filed on May 5, 2006.
(63) Continuation-in-part of application No. 11/448,240, filed on Jun. 6, 2006.
(63) Continuation-in-part of application No. 11/494,680, filed on Jul. 27, 2006.
(63) Continuation-in-part of application No. 11/506,262, filed on Aug. 18, 2006.
(63) Continuation-in-part of application No. 11/527,139, filed on Sep. 26, 2006.
(63) Continuation-in-part of application No. 11/641,368, filed on Dec. 18, 2006.

(51) Int. Cl. H04Q 7/00

(52) U.S. Cl. 370/328

(57) ABSTRACT

An end-point device that is attached to a primary access point delivers a detachment logic and network address of at least a secondary access point to the primary access point. The end-point device informs the primary access point about intended detachment. The detachment logic directs the primary access point to forward data destined for the end-point device to the secondary access point after detachment in anticipation that the end-point device will be attached to the secondary access point even if detached from the primary access point. The end-point device delivers the detachment logic anytime after attachment or after detachment from the primary access point. The detachment logic directs the primary access point to store session information and network association information so that the end-point device is relieved from re-establishing communication session and re-establishing association with a data network while switching attachment from the primary access point to another access point. The primary access point has an alternate pathway to communicate with the end-point device even after detachment.

### CROSS-REFERENCE TO RELATED APPLICATIONS/INCORPORATION BY REFERENCE

The present application is a continuation-in-part of;

1. U.S. Utility application Ser. No. 11/365,102, filed Mar. 1, 2006 and entitled “MULTIPLE NODE APPLICATIONS COOPERATIVELY MANAGING A PLURALITY OF PACKET SWITCHED NETWORK PATHWAYS,” (attorney docket No. BP5275);

2. U.S. Utility application Ser. No. 11/394,253, filed Mar. 30, 2006 and entitled “NETWORK NODES COOPERATIVELY ROUTING TRAFFIC FLOW AMONGST WIRED AND WIRELESS NETWORK,” (attorney docket No. BP5276);

3. U.S. Utility application Ser. No. 11/418.644, filed May 5, 2006 and entitled “PATHWAY PARAMETER EXCHANGE BETWEEN ACCESS NETWORKS OF DIFFERING TYPES,” (attorney docket No. BP5319);

4. U.S. Utility application Ser. No. 11/448,240, filed Jun. 6, 2006 and entitled “ACCESS POINT SUPPORTING DIRECT AND INDIRECT DOWNSTREAM DELIVERY BASED ON COMMUNICATION CHARACTERISTICS,” (attorney docket No. BP5329);

5. U.S. Utility application Ser. No. 11/494,680, filed Jul. 27, 2006 and entitled “INDIRECT COMMAND PATHWAYS BETWEEN AN END POINT DEVICE AND A TARGET ACCESS POINT VIA A SECONDARY ACCESS POINT,” (attorney docket No. BP5545);

6. U.S. Utility application Ser. No. 11/506,262, filed Aug. 18, 2006 and entitled “PRIMARY PROTOCOL STACK HAVING A SECONDARY PROTOCOL STACK ENTRY POINT,” (attorney docket No. BP5546);

7. U.S. Utility application Ser. No. 11/527,139, filed Sep. 26, 2006 and entitled “BRIDGING END POINT DEVICE SUPPORTING INTER ACCESS POINT COMMUNICATION,” (attorney docket No. BP5700); and

8. U.S. Utility application Ser. No. 11/641,368, filed Dec. 18, 2006 and entitled “ACCESS POINTS OF DIFFERENT TYPES EXCHANGING ADDRESSES AND RULES TO SUPPORT END POINT DEVICES,” (attorney docket No. BP5701), all of which claim priority to U.S. provisional application Ser. No. 60/736,889, filed Nov. 14, 2005, which is incorporated herein by reference for all purposes, and all of which are incorporated by reference herein in their entirety for all purposes.

### FEDERALLY SPONSORED RESEARCH OR DEVELOPMENT

[Not Applicable]

### SEQUENCE LISTING]

[Not Applicable]

### MICROFICHE/COPYRIGHT REFERENCE

[Not Applicable]

### BACKGROUND OF THE INVENTION

1. Field of the Invention

Various aspects of present invention relate to graceful detachment of a device from an access point by way of delivering detachment information to the access point via a variety of heterogeneous type of data networks.

2. Description of the Related Art

An end-point device which is typically a computer, notebook, phone, video game box, server, personal digital assistant etc. exchanges data packets with a remote end-point device by attaching to a first access point that belongs to a first packet switched data network. The remote end-point device is further attached to a second access point that belongs to a second packet switched data network that is typically communicatively incompatible with the first packet switched data network. The end-point device establishes an association with the first packet switched data network in order to establish a communication session with the remote end-point device via the first access point. The network association and the communication session are lost if the end-point device voluntarily or involuntarily detaches from the first access point at a later instant of time. The end-point device attaches with a third access point and re-establishes the communication session with the remote end-point device via the newly attached third access point at the later instant of time. The end-point device has to further re-establish network association even if the third access point belongs to the first packet switched data to which the recently detached first access point belongs. Re-establishment of communication session and network association typically requires furnishing password, security related information, information regarding settings of the end-point device, network parameters such as protocol version, desired data download and data upload speeds, desired QOS etc. Furnishing all above information every time the end-point device goes through a detachment and an attachment operation or every time the end-point device desires to interact with another remote end-point device via the currently attached first access point is time consuming.

Further limitations and disadvantages of conventional and traditional approaches will become apparent to one of ordinary skill in the art through comparison of such systems with various aspects of the present invention.

### BRIEF SUMMARY OF THE INVENTION

An end-point device that is attached to an access point gracefully detaches from the access point by way of delivering a detachment information to the access point via a variety of heterogeneous type of data networks and ensures further that the end-point continues receiving data packet from the access point even after detachment, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a schematic block diagram illustrating an end-point device in a communication infrastructure comprising a plurality of access points, each of the plurality of access points having personalized detachment information necessary for supporting communication with the end-point device after the end-point device gracefully detaches in accordance with various aspects of the present invention;

FIG. 2 is a schematic that shows interaction of a mobile end-point device with a plurality of access points as the end-point deice moves from one location to another location;

FIG. 3 is a schematic block diagram illustrating an end-point device with a single radio maintaining a communication session with a remote end-point device and in addition maintaining association with a communication network even after detaching from an access point via which the communication session and the association with the communication network were set up in the first place;

FIG. 4 is a, schematic block diagram illustrating a first end-point device controlled detachment operation wherein the first end-point device that interacts with a second end-point device via a first communication network continues interacting with the second end-point device during and after switching association from the first communication network to a second communication network;

FIG. 5 is a schematic block diagram illustrating a plurality of components of an end-point device that performs graceful detachment from an access point;

FIG. 6 is a schematic block diagram illustrating a plurality of components of an access point that delivers data packet to a detached downstream end-point device via an upstream pathway;

FIG. 7 is a flow chart illustrating a method of gracefully detaching from a primary access point and delivering data to the detached primary access point via a secondary access point by an end-point device;

FIG. 8 is a flow chart illustrating a method of delivering data to a downstream end-point device via an upstream pathway after the end-point device detaches by an access point; and

FIG. 9 is a flow chart illustrating a method of delivering data to a detached downstream end-point device by a first access point via an upstream pathway that comprises an internet backbone and a second access point 961.

### DETAILED DESCRIPTION

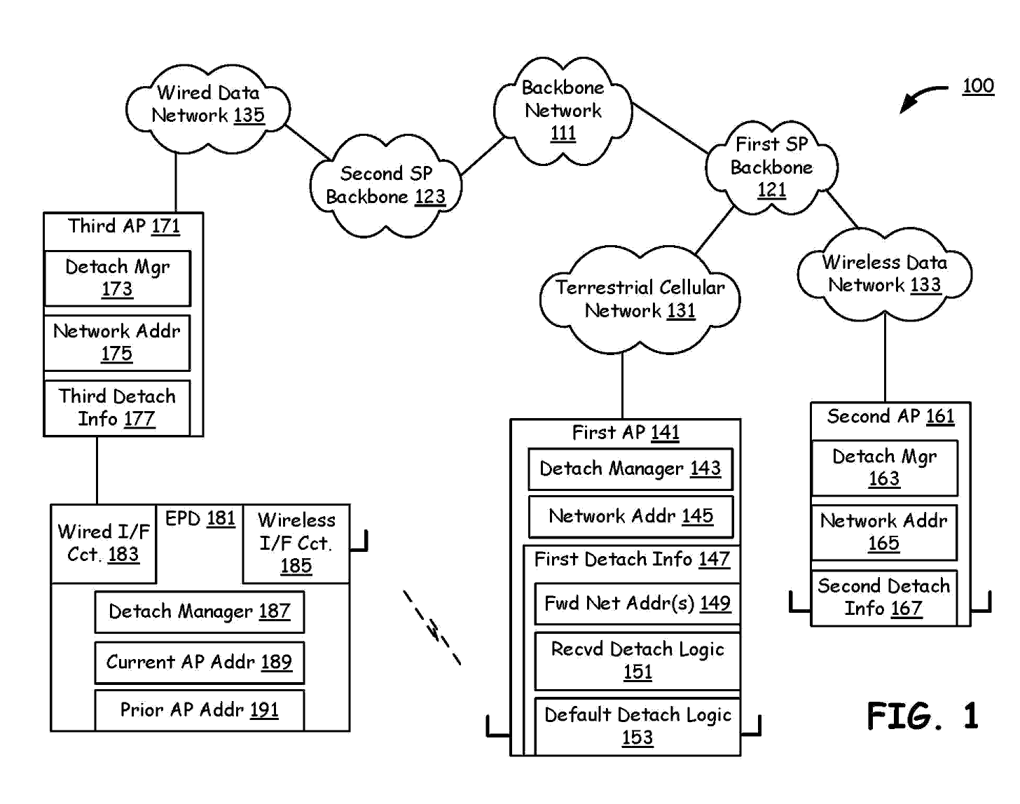

FIG. 1 is a schematic block diagram illustrating an end-point device 181 in a communication infrastructure 100 comprising a plurality of access points, 141, 161 and 171, each of the plurality of access points having personalized detachment information, 147, 167 and 177 necessary for supporting communication with the end-point device 181 after the end-point device 181 gracefully detaches. The end-point device (EPD) 181 is for example and without limitation, a personal computer (PC), notebook, phone, personal digital assistant (PDA), server, video game box etc. The EPD 181 comprises a wired interface (I/F) circuitry 183 and a wireless I/F circuitry 185. The EPD 181 is adapted to attach to two access points simultaneously, one attachment via the wired I/F circuitry 183 and another attachment via the wireless I/F circuitry 185. Attachment of the EPD 181 with any of the plurality of access points (AP), 141, 161 and 171 leads to an AP (141, 161 or 171) sending network address of the AP to the EPD 181 and the AP assigning a unique network address to the EPD 181. The AP and the EPD 181 agree to exchange data using the network address of the AP and the AP assigned unique EPD network address until the EPD 181 detaches from the AP (141, 161 or 171). The data is for example and without limitation, a music video, picture, voice, television program, multimedia game or any of a variety of real-time or archived multimedia information.

A first service provider (SP) maintains a terrestrial cellular network 131 and a wireless data network 133. A second service provider maintains a wired data network 135. A first SP backbone network 121 and a second SP backbone network 123 are communicatively coupled to a backbone network 111. The terrestrial cellular network 131, the wireless data network 133 and the wired data network 135 are thus communicatively coupled to each other via the upstream backbone network 111. A first access point (AP) 141, a second AP 161 and a third AP 171 belong to the terrestrial cellular network 131, the wireless data network 133 and the wired data network 135 respectively. The first AP 141, the second AP 161 and the third AP 171 are thus communicatively coupled to the backbone network 111 via respective data networks (131, 133 or 135). By way of example and without limitation, at a first instant of time the EPD 181 is attached to the third AP 171 via the wired I/F circuitry 183 and additionally attached to the first AP 141 via the wireless I/F circuitry 185. The EPD 181 stores network address of the third AP 171 and network address of the first AP 141 in a, memory (not shown here) of the EPD 181. The EPD 181 uses the network address of the third AP 171 and the network address of the first AP 141 to exchange data with the third AP 171 and the first AP 141 respectively. At a second instant of time the EPD 181 detaches from the first AP 141. Detachment of the EPD 181 from the first AP 141 (or an attached AP) is typically initiated by one or both of the first AP 141 (the attached AP) and the EPD 181. Various aspects of the present invention relate to EPD initiated detachment. A detachment manager 187 of the EPD 181 initiates and manages the detachment of the EPD 181 with an AP. The detachment, for example, occurs due to higher than permissible traffic load on the EPD 181 at the second instant of time, QOS of wireless communication link between the first AP 141 and the EPD 181 going below allowed level at the second instant of time etc.

The EPD 181 is attached to only the third AP 171 at the second instant of time. Prior AP address 191 stored in the memory of the EPD 181 refers to the network address of the first AP 141 and current AP address 189 refers to the network address of the third AP 171. The detachment manager 187 of the EPD 181 delivers forwarding network address(s) 149 and detachment logic 151 to the first AP 141 via the currently attached third AP 171 using the wired I/F circuitry 183. The detachment manager 187 directs the third AP 171 to forward the forwarding network address(s) 149 and the detachment logic 151 to the first AP 141 via the backbone network 111. The forwarding network address(s) 149 and the detachment logic 151 reach the first AP 141 via an upstream pathway that comprises the third AP 171, the wired data network 135, the second SP backbone 123, the backbone network 111, the first SP backbone 121 and the terrestrial cellular network 131. The first AP 141 receives the forwarding network address(s) 149 and the detachment logic 151 corresponding to the downstream detached EPD 181 via the upstream pathway.

The forwarding network address(s) 149 comprises the network address(s) of AP to which the EPD 181 is currently attached, i.e., the network address of the third AP 171 in the present example. The detachment logic 151 for example and without limitation, states that the first AP 141 is to forward data destined for the EPD 181 to AP(s) identified by the forwarding network address(s) 149 for an indefinite time or for a specified duration of time after detachment from the EPD 181, or to queue the data instead of forwarding for a specified duration of time after the detachment from the EPD 181, or to queue the data up to a specified size. The detachment logic 151 in addition states how many times the first AP 141 will attempt to forward the data using the forwarding network address(s) 149. In another embodiment the forwarding network address(s) 149 comprises a list of network addresses corresponding to more than one AP. In the another embodiment the detachment logic 151 sets an order in which the currently detached AP 141 will choose a network address from the list of network addresses for delivery of the data. The currently detached AP 141 forwards the data destined for the downstream EPD 181 via upstream terrestrial cellular network 131. The detachment logic 151 in addition tells the first AP 141 to preserve session information corresponding to communication session between the EPD 181 and the first AP 141 and to preserve association information corresponding to association of the EPD 181 with the terrestrial cellular network 131 for a defined period of time. The EPD 181 sends the detachment logic 151 to the detached AP 141 in anticipation that the EPD 181 may re-attach with the first AP 141 in near future and hence the EPD 181 ensures that the EPD 181 does not have to reestablish session with the first AP 141 and reestablish association with the terrestrial cellular network 131 when the EPD 181 re-attaches with the first AP 141. A detachment manager 143 of the first AP 141 triggers the first AP 141 to perform action(s) pursuant to the detachment logic 151 received from the EPD 181.

In yet another embodiment the EPD 181 sends the forwarding network address(s) 149 and the detachment logic 151 to the first AP 141 prior to detachment from the first AP 141 via the wireless I/F circuitry 185. The EPD 181 is adapted to send one or both of the forwarding network address(s) 149 and the detachment logic 151 just after attaching with the first AP 141 or any time thereafter or immediately prior to detaching from the first AP 141. The detachment manager 143 triggers the first AP 141 to perform actions pursuant to the detachment logic 151 after the EPD 181 detaches from the first AP 141.

The first AP 141 has a default detachment logic 153 stored in its memory. The detachment manager 143 of the first AP 141 causes the first AP 141 to accept the detachment logic 151 from the downstream EPD 181 (or any downstream EPD that is attached to the first AP 141) either via a downstream pathway or via an upstream pathway. The detachment manager 143 further triggers the first AP 141 to perform action(s) pursuant to the stored default detachment logic 153 if the first AP 141 does not receive the detachment logic 151 from the EPD 181 within a predefined period of time after detachment from the EPD 181. In another variant of the present invention the detachment manager 143 instructs the first AP 141 to act pursuant to the default detachment logic 153 until the first AP 141 receives the detachment logic 151 from the EPD 181. The default detachment logic 153 comprises, for example and without limitation, any one of following plurality of instructions for the first AP 141 to follow: never detach from the EPD 181 (or any currently attached EPD) unless told to do so, never detach from the EPD 181 (or any currently attached EPD) unless told to do so and data forwarding attempt via the third AP 171 (or any AP to which the EPD 181 is attached even after detaching from the first AP 141) fails, queue the data destined for the EPD 181 for a period of time if delivery of the data to the EPD 181 via downstream pathway fails and drop the session information and the association information corresponding to the EPD 181 after the time elapses, detach from the EPD 181 if attempts to deliver the data via the downstream pathway fails etc. In yet another variant of the present invention, the detachment logic 151 sent by the EPD 181 to the first AP 141 states that the EPD 181 intends to detach from the first AP 141. The detachment manager 143 in such a case instructs the first AP 141 to act pursuant to the default detachment logic 153.

As a way of example, the detachment logic 151 received by the first AP 141 from the EPD 181 instructs the first AP 141 to forward the data destined for the EPD 181 using the forwarding network address 149 i.e., network address 175. The first AP 141 encapsulates the data with the network address 175 and sends encapsulated data to the upstream terrestrial cellular network 131. The data reaches the third AP 171 via upstream backbone network 111 and the wired data network 135. The third AP 171 sends the data to the EPD 181 that receives that data via the wired I/F circuitry 183. The data from the currently detached AP 141 gets delivered to the EPD 181 via, an upstream pathway that comprises communicatively incompatible networks, the terrestrial cellular network 131 and the wired data network 135, pursuant to the detachment logic 151 sent to the first AP 141 by the EPD 181.

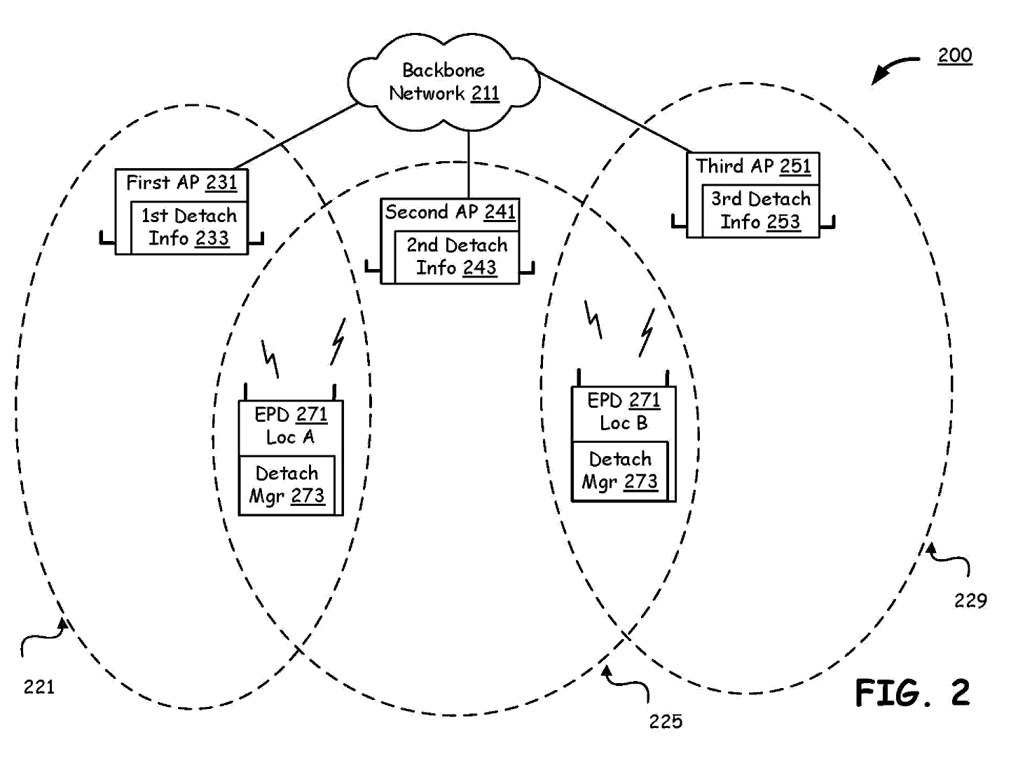

FIG. 2 is a schematic that shows interaction of a mobile end-point device 271 with a plurality of access points 231, 241 and 251 as the EPD 271 moves from one location (location A) to another location (location B). A first area 221 is an area serviced by a first AP 231. A second area 225 is an area serviced by a second AP 241 and a third area 229 is an area serviced by a third AP 251. At a first instant of time the EPD 271 is located at the location A. Then location A is serviced by both the first AP 231 and the second AP 241. Thus at the first instant of time the EPD 271 is attached to the first AP 231 and additionally attached to the second AP 241. The EPD 271 exchanges data with the first AP 231 and the second AP 241 via its two radio circuitry (not shown here). The first AP 231 and the second AP 241 may manage communicatively incompatible communication networks. As a way of example the first AP 231 manages a circuit switched data network and the second AP 241 manages a packet switched data network. The first AP 231 and the second AP 241 are communicatively coupled to each other via an upstream backbone network 211.

Detachment manager 273 of the EPD 271 is software running on a hardware circuitry. The detachment manager 273 directs the EPD 271 to send network address of the second AP 241 and first detachment logic to the first AP 231 upon attachment with the first AP 231. The detachment manager 273 further directs the EPD 271 to send network address of the first AP 231 and second detachment logic to the second AP 241 upon attachment with the second AP 241. In other words the EPD 271 is directed to send network address of currently attached AP(s) and detachment logic to each of the currently attached AP(s). Each of the currently attached AP(s) is made aware of network address of remaining of the currently attached AP(s). In another embodiment the detachment manager 273 directs the EPD 271 to send network address and detachment logic to an attached AP anytime after attaching with the AP. The EPD 271 sends the network address and the detachment logic to the AP via one of its two radio circuitry. In yet another embodiment the detachment manager 273 triggers the EDP 271 to send the network address and the detachment logic to an AP after the EPD 271 detaches from the AP. In the yet another embodiment the EPD 271 delivers the network address and the detachment logic to the detached AP via one or more currently attached AP(s) and via the upstream backbone network 211. The detachment logic sent to an AP by the EPD 271 comprises a plurality of rules and the AP acts pursuant to the detachment logic after detaching from the EPD 271. Thus how an AP handles data communication with the EPD 271 after detaching from the EPD 271 is controlled by the EPD 271. As a way of example and without limitation, the detachment logic directs the AP to do one or more of following: (1) drop data destined for the EPD 271 as soon as the AP finds that the EPD 271 has detached from the AP, (2) queue the data for a predefined period of time, (3) queue the data until stored data size exceeds a predefined limit, (4) forward the data via an upstream pathway comprising the upstream backbone network 211 and one or more of AP(s) to which the EPD 271 is currently attached, (5) receive data sent by the EPD 271 to the AP via the upstream pathway, (6) queue the data and exchange signaling information with the EPD 271 until the EPD 271 re-attaches, (7) attempt to deliver the data to the EPD 271 via the upstream pathway for a predefined number of times and drop the data if all delivery attempts fail, (8) store session information corresponding to communication session of the EPD 271 with the AP and network association information corresponding to association of the EPD 271 with communication network that the AP manages, such that the session information and the network association information can be retrieved when the EPD 271 re-attaches with the AP at a later instant of time, etc.

As a way of example, a second instant of time the EPD 271 moves to the location B. The location B is serviced by the second AP 241 and the third AP 251. The EPD 271 detaches from the first AP 231, remains attached with the second AP 241 and attaches with the third AP 251 while at the location B. The first AP 231 has the network address of the second AP 241 and the first detachment logic sent by the EPD 271. The first AP 231 has a first default detachment logic stored in its memory. First detachment information 233 comprises the network address of the second AP 241, the first detachment logic and the first default detachment logic. The first AP 231 delivers the data destined for the EPD 271 pursuant to the first detachment logic after the EPD 271 detaches from the first AP 231. The data comprises data received by the first AP 231 from the upstream backbone network 211 and destined for the EPD 271 and signaling information generated by the first AP 231. The first AP 231 encapsulates the data with the network address of the second AP 241 and delivers the encapsulated data to the EPD 271 via the upstream backbone network 211 and the second AP 241. The EPD 271 in spite of being detached from the first AP 231, while at the location B, receives the data from the first AP 231 via the currently attached AP 241.

The second AP 241 exchanges data with the downstream EPD 271 via downstream pathway as long as the EPD 271 remains attached to the second AP 241. The third AP 251, being attached to the EPD 271 at the second instant of time, exchanges data with the EPD 271 via another downstream pathway. “Downstream pathway” refers to a pathway that does not pass through the backbone network 211. The EPD 271 sends the network address of the second AP 241 and a third detachment logic to the third AP 251 upon attachment with the third AP 251. The EPD 271 in addition sends network address of the third AP 251 to the second AP 241. The EPD 271 further informs the second AP 241 not to use the network address of the first AP 231 that the EPD 271 sent to the second AP 241 at the first instant of time. The EPD 271 updates each of currently attached AP(s) about network address(s) of rest of the currently attached AP(s). The mobile EPD 271 further sends detachment logic to each of the currently attached AP(s) so that the mobile EPD 271 can exchange data with any of the currently attached AP(s) even after detaching from each of the currently attached AP(s) at a third instant of time. However at the third instant of time the EPD 271 has to remain attached to at least one AP that is communicatively coupled to the backbone network 211. The mobile EPD 271 is one of a notebook, phone, PDA etc.

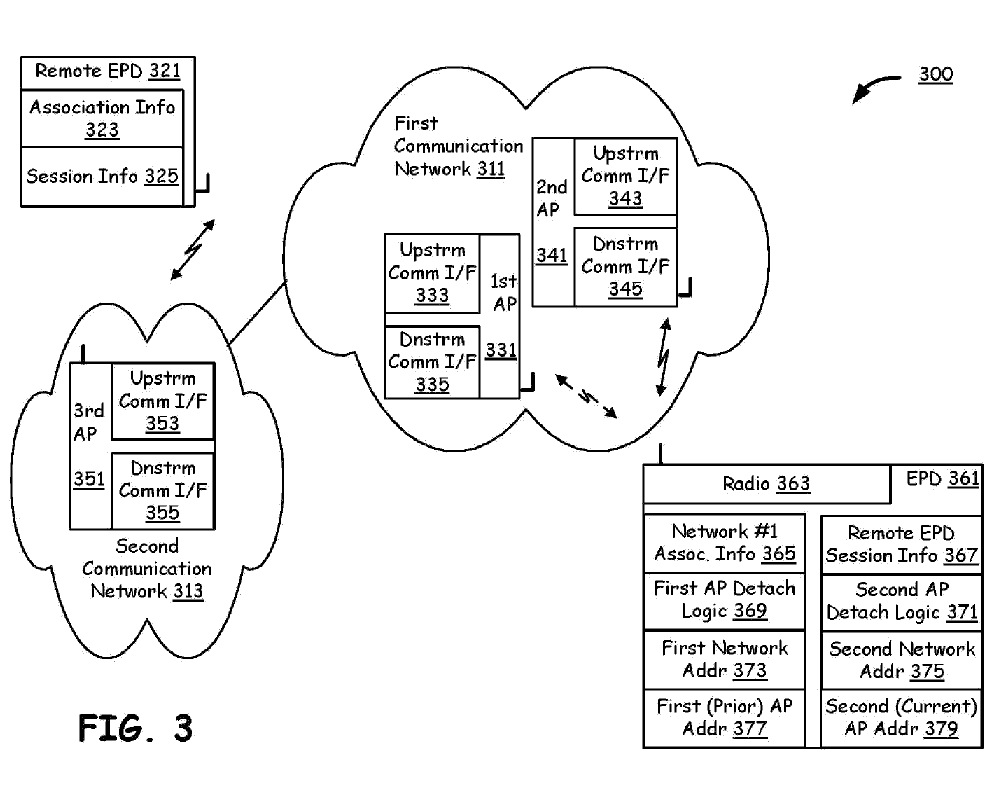

FIG. 3 is a schematic block diagram illustrating an end-point device (EPD) 361 with a single radio 363 maintaining a communication session with a remote end-point device 321 and in addition maintaining association with a communication network 311 even after detaching from an access point (AP) 331 via, which the communication session and the association with the communication network 311 were set up in the first place. The EPD 361 attaches with first AP 331 at a first instant of time and exchanges data with the first AP 331 via the radio 363. The first AP 331 uses downstream communication I/F 335 to exchange data with the attached downstream EPD 361. The EPD 361 receives a first AP address 377 and a first network address 373 from the first AP 331 upon association. The first AP address 377 uniquely identifies the first AP 331. The remote EPD 361 is attached to a third AP 351 at the first instant of time. The EPD 361 and the remote EPD 361 exchange data via the first AP 331 and the third AP 351. The first AP 331 and a second AP 341 belong to the communication network 311 and are communicatively coupled to each other (not shown here). The communication network 311 which is also denoted as a first communication network is one of a wireless network and wired network. The third AP 351 belongs to a second communication network 313 which is communicatively coupled to the first communication network 311. The first AP 331, the second AP 341 and the third AP 351 are thus communicatively coupled to each other.

At a second instant of time the EPD 361 decides to detach from the first AP 331 and attach with the second AP 341. The EPD 361 decides to detach because of one or more of, for example and without limitation, communication link between the first AP 331 and the EPD 361 goes below an acceptable level, the EPD 361 moves away from coverage area of the first AP 331 and enters coverage area of the second AP 341, quality of communication link between the second AP 341 and the EPD 361 is better than quality of the communication link between the first AP 331 and the EPD 361 at the second instant of time etc. The EPD 361 sends a first AP detachment logic 369 to the first AP 331 via the radio 363 prior to detaching from the first AP 331. The first AP detachment logic 369 comprises a plurality of instructions for the first AP 331 to follow. The first AP 331 receives the first AP detachment logic 369 from the EPD 361 via the downstream communication I/F 335 and acts pursuant to the detachment logic 369. The first AP detachment logic 369 directs the first AP 331 to do one or more of following: (1) queue the data destined for the EPD 361 for a predefined period of time after detachment form the EPD 361, (2) queue the data until stored data size exceeds a predefined limit, (3) receive and/or retrieve a forwarding address, (4) forward the data via an upstream communication I/F 333 using the forwarding address, (5) receive data from the EPD 361 via the upstream communication I/F 333, (6) queue the data and exchange signaling information with the EPD 361 until the EPD 361 re-attaches, (7) store network association information corresponding to association of the EPD 361 with the first communication network 311, (8) forward the stored network association information to the EPD 361 via the upstream communication I/F 331 and using the forwarding address, (9) store session information corresponding to the communication session of the EPD 271 with the remote EPD 321, (10) forward the stored session information to the EPD 361 using the forwarding address, (11) forward the stored session information to another AP via the upstream communication I/F 331 and using the forwarding address, (12) forward the stored network association information to the another AP via the upstream communication I/F 331 and using the forwarding address etc. The EPD 361 detaches from the first AP 331 and attaches with the second AP 341 via the radio 341 at a third instant of time. The EPD 361 retrieves the network association information 365 and the session information 367 from the first AP 331 via the second AP 341 at the third instant of time. The EPD 361 further directs the second AP 341 to use the network association information 365 and the session information 367. The EPD 361, by way of sending the first AP detachment logic 369 to the first AP 331, ensures that the EPD 361 continues receiving data from the first AP 331 even after detaching from the first AP 331 and in addition ensures that the EPD 361 does not have to re-establish the communication session with the remote EPD 321 and re-establish the association with the first communication network 311 because of detachment and attachment operations.

The EPD 361 receives second AP address 379 from the second AP 341 upon attachment with the second AP 341 at the third instant of time. The EPD 361 delivers the second AP address 379 to the first AP 331 via the second AP 341. The first AP 331 uses the second AP address 379 as the forwarding address for forwarding EPD related information to the EPD 361 after detachment from the EPD 361. The EPD 361 sends data to the first AP 331, if necessary, via the second AP 341. Data is exchanged between the EPD 361 and the first AP 331 via upstream communication I/F 333 of the first AP 331, upstream communication I/F 343 of the second AP 341, downstream communication I/F 345 of the second AP 341 and the radio 363 of the EPD 361. The EPD 361 and the second AP 341 exchange data using the radio 363 of the EPD 361 and the downstream communication I/F 345. Association information 323 stored in the remote EPD 321 refers to information corresponding to association of the remote EPD 321 with the second communication network 313. Session information 325 stored in the remote EPD 321 refers to information corresponding to the ongoing communication session between the remote EPD 321 and the EPD 361.

The EPD 361 remains associated with the first communication network 311 all the time even though the EPD 361 switches attachment from the first AP 331 to the second AP 341. The EPD 361 uses the retrieved network association information 365 and does not re-establish the association with the first communication network 311 while switching attachment from the first AP 331 to the second AP 341. The EPD 361 exchanges data with the remote EPD 321 via the first AP 331 at the first instant of time. The EPD 361 uses the retrieved session information 367 and does not re-establish the communication session with the remote EPD 321 after detaching from the first AP 331. The EPD 321 continues exchanging data with the remote EPD 321 but via the second AP 341 from the third instant of time onwards. EPD controlled detachment saves time required for re-establishing association with the first communication network 311 and time for re-establishing session with the remote EPD 321.

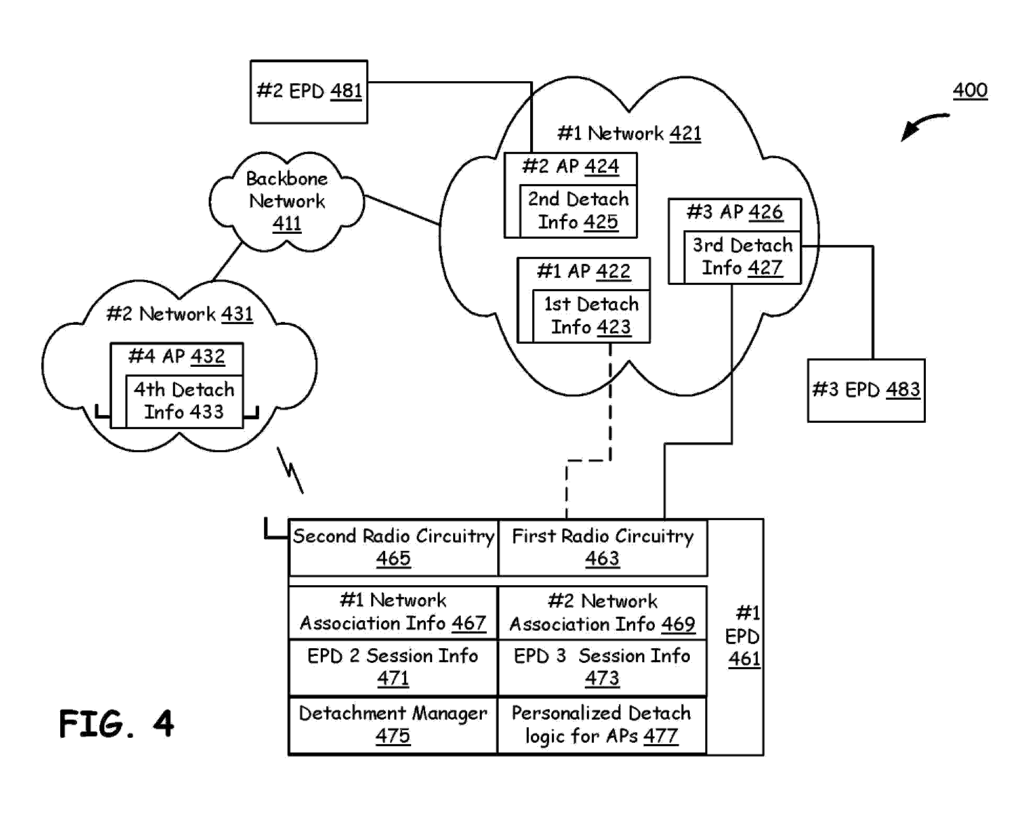

FIG. 4 is a schematic block diagram illustrating a first end-point device 461 controlled detachment operation wherein the first end-point device 461 that interacts with a second end-point device 481 via a first communication network 421 continues interacting with the second end-point device 481 during and after switching association from the first communication network 421 to a second communication network 431. The first EPD 461 is attached to a first AP 422 via a wired link and a first radio circuitry 463 at a first instant of time. The first AP 422 belongs to the first communication network 421. The first EPD 461 is thus associated with the first communication network 421 by way of attachment with the first AP 422. The first communication network is one of a fiber optic network, PSTN network, cable network etc. The first EPD 461 exchanges data with a second EPD 481 at the first instant of time. The data is one or more of a voice, video, text, picture, television program, multimedia game or any of a variety of archived and/or live multimedia information. The second EPD 481 is attached to a second AP 424, that belongs to the first communication network 421, at the first instant of time. All AP(s) that belong to the first communication network 421 are communicatively coupled to each other. Ongoing communication session between the first EPD 461 and the second EPD 481 runs via the first AP 422 and the second AP 424. The first EPD 461, the first AP 422, the second AP 424 and the second EPD 481 have partial or full information corresponding to the ongoing communication session between the first EPD 461 and the second EPD 481.

The first EPD 461 detaches from the first AP 422 at a second instant of time. The detachment is initiated by the first EPD 461 because of one or more of for example and without limitation, following reasons: (1) the wired link between the first EPD 461 and the first AP 422 breaks at the second instant of time, (2) at the second instant of time the first EPD 461 moves to a location not serviced by the first AP 422, (3) the first EPD 461 wants to put off the first radio circuitry 463 to save battery life, (4) QOS provided by the first AP 422 is below acceptable level, etc. The first EPD 461 intends to maintain association with the first communication network 421 and additionally to maintain session with the second AP 481 even after detaching from the first AP 422. Towards this end detachment manager 475 of the first EPD 461 directs the first EPD 461 to send a detachment notice to the first AP 422 prior to detachment via the first radio circuitry 463. The detachment manager 471 further directs the first EPD 461 to send first detachment information 423 to the first AP 422. The first AP 422 acts in pursuant to the first detachment information 423 received from the first EPD 461. The first detachment information 423 triggers the first AP 422 to store association information corresponding to the association of the first EPD 461 with the first communication network 421 and additionally to store session information corresponding to the ongoing communication session with the second EPD 481.

The first EPD 461 attaches with a fourth AP 432 via a wireless link and a second radio circuitry 465. Tile fourth AP 432 belongs to a second communication network 431 that is one of a terrestrial cellular network, wireless local area network, wireless metropolitan area network, Bluetooth network or any of a variety of proprietary or public wireless network. Tie first EPD 461 thus creates an association with the second communication network 431 by way of attaching with the fourth AP 432. The first communication network 421 and the second communication network 431 are communicatively coupled to each other via a backbone network 411. Tile first EPD 461 attaches with the fourth AP 432 after detaching from the first AP 422. In another embodiment the first EPD 461 attaches with the fourth AP 432 before detaching from the first AP 422.

The first EPD 461 receives network address of the fourth AP 432 upon attachment with the fourth AP 432. The detachment manager 475 of the first EPD 461 triggers the first EPD 461 to send the network address of the fourth AP 432 to the first AP 422 via the second radio circuitry 465 and further to instruct the first AP 422 to deliver the association information and the session information to the first EPD 461 using the network address of the fourth AP 432. The first AP 422, in spite of being detached from the first AP 461 at the second instant of time, is adapted to deliver the association information and the session information to the first AP 461 via an alternate upstream pathway. The alternate upstream pathway traverses through upstream communication I/F (not shown here) of the first AP 422, the first communication network 421, the backbone network 411, the second communication network 431 and the upstream communication I/F (not shown here) of the fourth AP 432. The fourth AP 432 sends the association information 467 and the session information 471 to the first EPD 461 via the wireless link. The first EPD 461 interacts with the second EPD 481 via the fourth AP 432 from the second instant of time onwards. The first EPD 461 uses the session information 471 so that the first EPD 461 need not re-establish communication session with the second EPD 481 as the first EPD 461 switches association from the first communication network 421 to the second communication network 431. Communication session between the first EPD 461 and the second EPD 481 runs via the fourth AP 432, the backbone network 411 and the second AP 424. Tile communication session runs via two heterogeneous communication networks 421 and 431 from the second instant of time onwards.

The first EPD 461 intends to set up a second communication session with a third EPD 483 at a third instant of time. The first EPD 461 attaches with a third AP 426 in order to set up the second communication session. The third AP 426 belongs to the first communication network 421. The first EPD 461 uses the association information 467 received from the first AP 422 via the fourth AP 432 while attaching with the third AP 426 so that the first EPD 461 need not re-establish association with the first communication network 421 at the third instant of time. The second communication session between the first EPD 461 and the third EPD 483 runs via the first radio circuitry 463 and the third AP 426.

Third detachment information 427 and fourth detachment information 433 are a plurality of rules that the third AP 426 and the fourth AP 432 follow respectively after detaching from the first EPD 461. The third AP 426 is instructed by the first EPD 461 to store and later forward session information 473 corresponding to the second communication session between the first EPD 461 and the third EPD 483. The fourth AP 432 is instructed by the first EPD 461 to store and later forward association information 469 corresponding to association of the first EPD 461 with the second communication network 431.

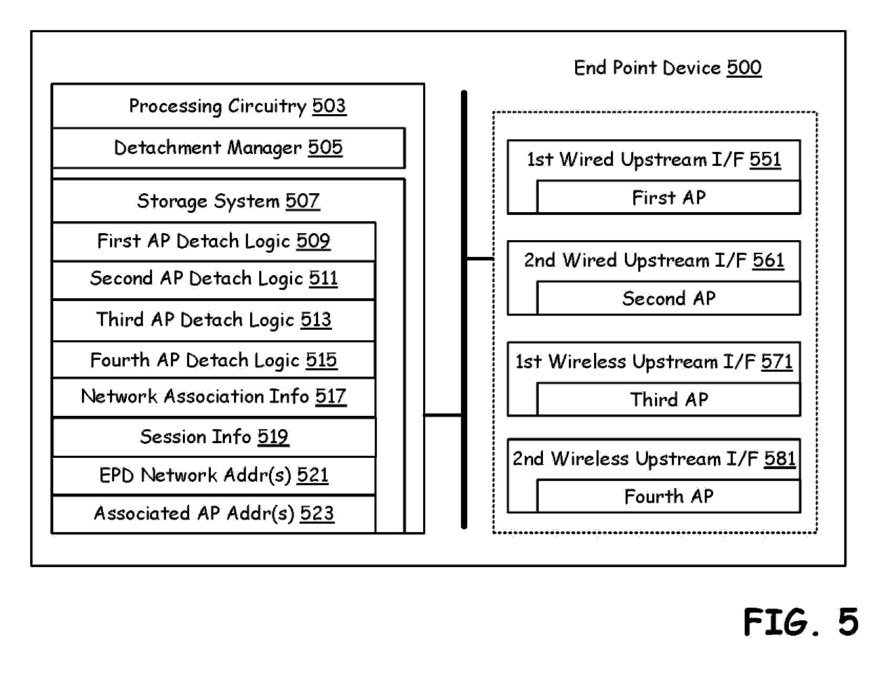

FIG. 5 is a schematic block diagram illustrating a plurality of components of an end-point device 500 that performs graceful detachment from an access point. The EPD 500 comprises a first wired upstream I/F 551 via which the EPD 500 is attached to a first AP. The EPD 500 further comprises a second wired upstream I/F 561 via which the EPD 500 is attached to a second AP. The EPD 500 is attached to a third AP and to a fourth AP via a first wireless upstream I/F 571 and a second wireless upstream I/F 581 respectively. The EPD 500 comprises a detachment manager 505. The detachment manager 505 is a one or more of a software and hardware that directs the EPD 500 to detach from an attached AP (the first AP or the second AP or the third AP or the fourth AP) gracefully. The detachment manager 505 handles operation(s) related to graceful detachment of the EPD 500 from the attached AP. The EPD 500 comprises a storage system 507 that stores a plurality of network addresses of the AP(s) 523 with which the EPD 500 is currently associated. The EPD 500, directed by the detachment manager 505, is adapted to store network address of a detached AP with which the EPD 500 was attached earlier. The EPD 500 receives a network address from an AP upon attachment with the AP. The EPD 500 stores a plurality of EPD addresses 521, each of the plurality of EPD addresses 521 corresponding to a different AP attachment.

The EPD 500 generates and stores personalized detachment logic for each of attached AP (the first AP, the second AP, the third AP and the fourth AP). The EPD 500 delivers first AP detachment logic 509 to the first AP (1) upon attachment with the first AP or (2) any time after attachment with the first AP or (3) immediately prior to detachment from the first AP or (4) immediately after detachment from the first AP. The EPD 500 delivers the first AP detachment logic 509 to the first AP via a direct communication pathway that comprises a downstream I/F of the first AP in case (1), (2) and (3). The EPD 500 delivers the first AP detachment logic 509 via an indirect communication pathway that comprises another AP and an upstream communication I/F of the first AP in case (4). The EPD 500 chooses the indirect communication pathway in case (4) because the first AP, being detached from the EPD 500, is unreachable via the direct communication pathway. The EPD 500 is further adapted to deliver second AP detachment logic 511, third AP detachment logic 513 and fourth AP detachment logic 515 to the second AP, the third AP and the fourth AP respectively as per one option chosen from options (1), (2), (3) and (4).

Any of the personalized detachment logics (509, 511, 513 and 515) comprises a plurality of rules associated with detachment of the EPD 500 with corresponding AP. The corresponding AP acts in pursuant to the personalized detachment logic. As a way of example and without limitation, the first AP detachment logic 509 comprises an instruction to act in pursuant to default detachment logic after the EPD 500 detaches from the first AP. The first AP, in pursuant to the first AP detachment logic 509, acts in pursuant to the default detachment logic, that is stored in the first AP, after the EPD 500 detaches from the first AP. The default detachment logic directs the first AP to perform following actions: (1) attempt to deliver data destined for the EPD 500 via an alternate path after the EPD 500 detaches, (2) drop the data after attempting for a predefined period of time, (3) store network association information corresponding to association of the EPD 500 with a first communication network (not shown here) to which the first AP belongs, (4) store session information corresponding to most recent communication session of the first AP with the EPD 500 etc.

The second AP detachment logic 511 comprises a plurality of forwarding addresses and a plurality of rules for the second AP to follow. The second AP detachment logic 511 directs the second AP to perform the following actions: (1) attempt to deliver data destined for the EPD 500 using the plurality of forwarding addresses after the EPD 500 detaches from the second AP, (2) drop the data if attempt using each of the plurality of the forwarding addresses fails, (3) store network association information corresponding to association of the EPD 500 with a second communication network (not shown here) to which the second AP belongs, (4) store session information corresponding to most recent communication session of the second AP with the EPD 500 etc. The detachment manager 505 of the EPD 500 generates personalized detachment logic for each of currently attached AP(s) and directs the EPD 500 to deliver personalized detachment logic to corresponding AP according to one of the options (1), (2), (3) and (4). The EPD 500 retrieves the network association information and the session information from corresponding AP. The EPD 500 uses the network association information retrieved from the first AP when the EPD 500 re-attaches with the first AP or attaches with another AP that belongs to the first communication network at a later instant of time. The EPD 500 attaches with the first AP typically to exchange data with a remote EPD via the first AP. The EPD 500 uses the session information if the EPD 500 desires to maintain ongoing data exchange with the remote EPD via a different AP after detaching from the first AP.

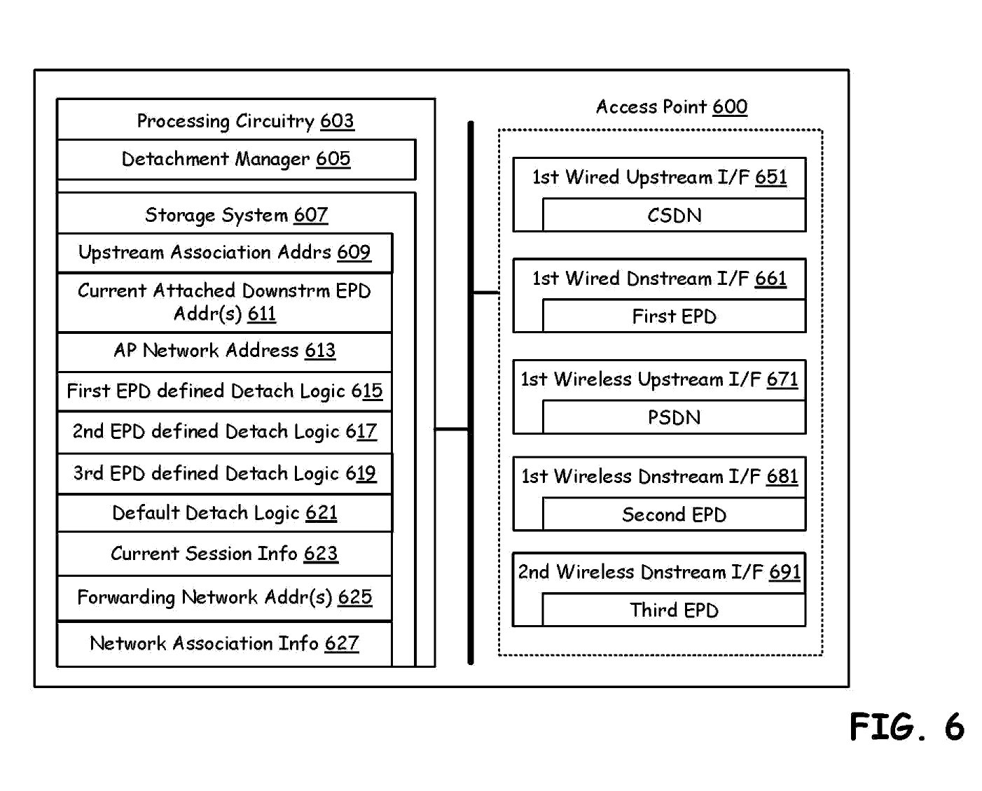

FIG. 6 is a schematic block diagram illustrating a plurality of components of an access point 600 that delivers data packet to a detached downstream end-point device via an upstream pathway. The AP 600 comprises a first wired upstream I/F 651 via which the AP 600 is communicatively coupled to a circuit switched data network (CSDN) and a first wireless upstream I/F 671 via which the AP 600 is communicatively coupled to a packet switched data network (PSDN). The AP 600 further comprises a first wired downstream I/F 661 via which the AP 600 is attached to a first EPD. The AP 600 is attached to a second EPD and a third EPD via a first wireless downstream I/F 681 and a second wireless downstream I/F 691 respectively. The circuit switched data network and the packet switched data network are communicatively coupled to each other via a backbone network. “Upstream node” refers to a network node that is located closer to the backbone network than an EPD (the first EPD, the second EPD or the third EPD) with respect to the AP 600. “Downstream node” refers to a network node that is located closer to the EPD than the backbone network with respect to the AP 600.

The AP 600 is uniquely identified by a network address 613. The AP 600 stores the AP network address 613 in a storage system 607 of the AP 600. The AP 600 communicates with the upstream CSDN and the upstream PSDN via a first node that belongs to the CSDN and a second node that belongs to the PSDN respectively. Upstream association addresses 609 refer to network addresses of the first node and the second node. The EPDs (the first EPD, the second EPD and the third EPD) with which the AP 600 is attached are identified by respective unique network addresses. Currently attached downstream EPD addresses 611 refer to unique network addresses of the first EPD, the second EPD and the third EPD.

The AP 600 has a default detachment logic 621 stored in the storage system 607. Detachment manager 607, which is a combination of one or more of software and hardware, directs the AP 600 to act in pursuant to the default detachment logic 621 when the AP 600 detaches from a currently attached EPD. The default detachment logic 621 directs the AP 600 to perform, for example and without limitation, one or more of following actions: (1) detach from a currently attached downstream EPD if attempt to send data to the downstream. EPD via downstream I/F fails, (2) attempt to deliver the data to the downstream EPD via an alternate upstream pathway if attempt via the downstream I/F fails, (3) drop the data if repeated attempt to deliver the data via the alternate upstream pathway during a predefined period of time fails, (4) act in pursuant to a detachment logic received from the downstream EPD and ignore the default detachment logic 621, (5) never detach from the currently attached EPD unless told by the EPD to detach, (6) queue the data for a predefined period of time if attempt to deliver the data to the downstream EPD via the downstream I/F fails, (7) store session information 623 corresponding to ongoing communication session between the downstream EPD and the AP 600 and additionally store network association information 627 corresponding to association of the downstream EPD with an upstream data network if the attempt to send the data via the downstream I/F fails most recent etc. The downstream EPD typically communicates with a remote client or a server via the AP 600. The downstream EPD receives the session information 623 from the AP 600 after detaching from the AP 600 and uses the session information 623 while attempting to communicate with the remote client or the server via a second AP. Availability of the session information 623 relieves the downstream EPD from reestablishing a communication session with the remote client or the server. The downstream EPD receives the network association information 627 from the AP 600 and uses the network association information 627 while attempting to attach with another AP belonging to the upstream data network. Availability of the network association information 627 relieves the downstream EPD from re-establishing association with the upstream data network.

The AP 600 is further adapted to receive a detachment logic from any of currently attached EPDs (the first EPD, the second EPD and the third EPD) and store in the storage system 607. The AP 600 is adapted to receive the detachment logic either immediately after attaching to an EPD or anytime after attachment and prior to detachment or after detaching from the EPD. A first EPD defined detachment logic 615 comprises a plurality of steps that the AP 600 follows after the first EPD detaches from the AP 600. The AP 600 has a plurality of forwarding network addresses 625 stored in the storage system 607. The AP 600 receives the plurality of forwarding network addresses 625 from the currently attached EPDs. The plurality of forwarding network addresses 625 are typically network addresses of a first plurality of APs with which the currently attached EPDs are attached in addition to being attached with the AP 600 and/or network addresses of a second plurality of APs with which the currently attached EPDs are expected to remain attached even after detaching from the AP 600. As a way of example and without limitation, the first EPD is currently attached to a third AP in addition to being attached to the AP 600. The first EPD sends network address of the third AP to the AP 600 immediately prior to detaching from the AP 600 in anticipation that the first EPD will remain attached to the third AP even after detaching from the AP 600. The plurality of forwarding network addresses 625 comprises the network address of the third AP in the example. The AP 600, in response to the default detachment logic 621 or the first EPD defined detachment logic 615, uses the network address of the third AP to forward data to the first EPD if attempt to send the data to the first EPD via the first wired downstream I/F 661 fails. The first EPD ensures that the first EPD continues receiving the data from the AP 600 even after detaching from the AP 600. The AP 600 in addition is able to communicate with the detached first EPD by using the network address of the third AP (or the plurality of forwarding network addresses 625).

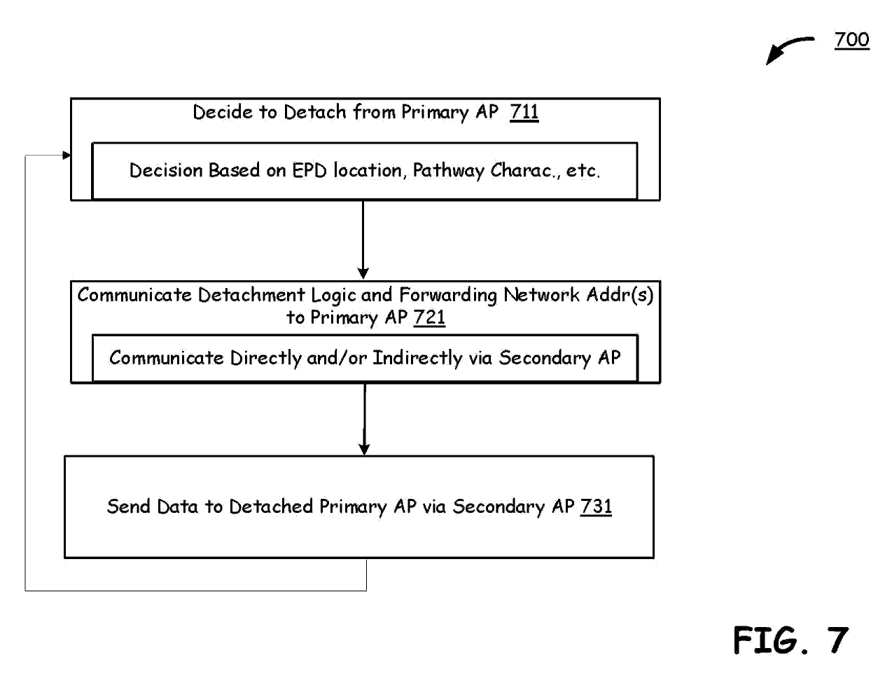

FIG. 7 is a flow chart illustrating a method of gracefully detaching from a primary access point and delivering data to the detached primary access point via a secondary access point by an end-point device. The EPD decides to detach from the primary AP at a step 711. The EPD takes decision based on one or more of, for example, following reasons, (1) the EPD moves to a location which is not serviced by the primary AP, (2) QOS of a first communication link between the EPD and the primary AP is below an acceptable level, (3) delay in a communication network to which the primary AP belong is more than an acceptable level, (4) the EPD decides to switch off a radio via which the EPD is interacting with the primary AP, (5) QOS of a second communication link between the EPD and the secondary AP is better than the QOS of the first communication link etc. The EPD detaches from the primary AP gracefully at a next step 721 by informing the primary AP about detachment. In one embodiment the EPD informs the primary AP about the detachment immediately prior to detaching from the primary AP. The EPD sends detachment logic and a plurality of forwarding addresses to the primary AP via the first communication link prior to detachment. The first communication link is also called a direct link between the EPD and the primary AP because the first communication link passes through downstream communication I/F of the primary AP. The plurality of forwarding addresses are network addresses of a plurality of APs other than the primary AP with which the EPD is currently attached. The detachment logic comprises a plurality of actions that the primary AP follows after the EPD detaches from the primary AP. One of the plurality of actions is to forward data destined for the EPD to the EPD using the plurality of network addresses after the EPD detaches from the primary AP. The EPD expects to remain attached to the plurality of APs even after the EPD detaches from the primary AP at a later instant of time and ensures that the EPD receives the data from the primary AP via at least one of the plurality of APs even after detaching from the primary AP.

In another embodiment the EPD informs the primary AP about the intended detachment immediately prior to detaching from the primary AP and delivers the detachment logic and the plurality of forwarding addresses to the primary AP after detachment. The EPD chooses the secondary AP from a second plurality of APs with which the EPD is attached after detaching from the primary AP. The EPD delivers the detachment logic and the plurality of forwarding addresses to the primary AP via the second communication link at the step 721. The primary AP and the secondary AP (and any other AP) are communicatively coupled to each other via an upstream backbone network. The upstream backbone network is so called because the primary AP and the secondary AP (and any other AP) are communicatively coupled to the backbone network via their respective upstream communication I/Fs. The secondary AP delivers the detachment logic and the plurality of forwarding addresses to the primary AP via the upstream backbone network. One of the plurality of forwarding addresses is a network address of the secondary AP so that the primary AP can forward data packet destined for the EPD to the secondary AP after the EPD detaches from the primary AP. The EPD sends data to the detached primary AP via the currently attached secondary AP after detaching from the primary AP as shown in a next step 731. The data may is one or more of control information, live and/or archived multimedia information.

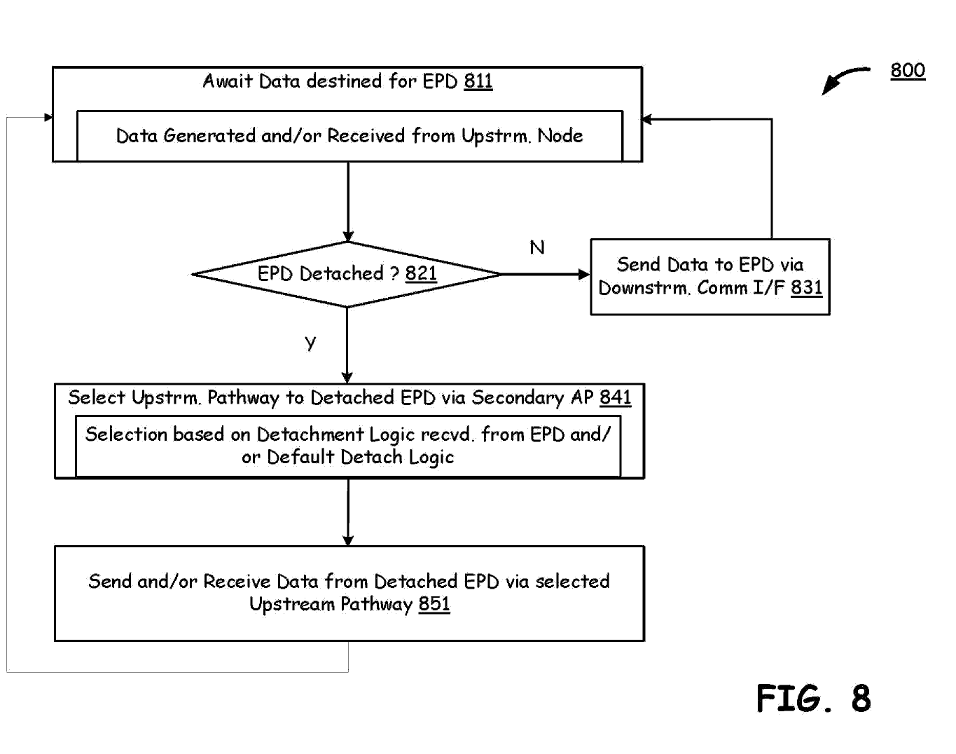

FIG. 8 is a flow chart illustrating a method of delivering data to a downstream end-point device via an upstream pathway after the end-point device detaches by an access point. The AP waits for data destined for the downstream EPD as shown in a step 811. The AP is communicatively coupled to the EPD via a downstream communication I/F. The AP comprises at least one upstream communication I/F via which the AP is communicatively coupled to a backbone network. Any AP in this embodiment is communicatively coupled to the backbone network via its upstream communication I/F. The EPD communicatively couples to an AP via downstream communication I/F of the AP. The AP either generates the data or receives the data from an upstream network node (or the backbone network). The data comprises one or more of a signaling information, any of a variety of live and/or archived multimedia information. The AP determines if the AP is currently attached to the downstream EPD in a next step 821. The AP sends the data to the EPD via the downstream communication I/F of the AP in a step 831 if the AP determines that the EPD is currently attached to the AP.

The AP selects an alternate pathway to the downstream EPD if the AP determines that the EPD is detached from the AP at the step 821. The AP has a default detachment logic stored in a memory of the AP. The AP uses the default detachment logic for selecting an alternate pathway to the downstream EPD. The AP is further adapted to receive detachment logic from the downstream EPD anytime before and/or after detachment from the EPD. The received detachment logic overrides the default detachment logic and the AP acts in pursuant to the received detachment logic. The AP acts in pursuant to the default detachment logic if the AP does not receive the detachment logic from the downstream EPD. The default/received detachment logic triggers the AP to choose an AP with which the downstream EPD is currently attached. As a way of example the AP selects a secondary AP. The AP is directed by the default/received detachment logic to forward the data destined for the downstream EPD to the secondary AP as shown in a next step 841. The AP is communicatively coupled to the secondary AP via the backbone network. The upstream pathway via which the AP delivers the data to the downstream EPD comprises the backbone network and the secondary AP. The AP is typically provided with network address of the secondary AP by the EPD. The AP continues to send and receive data from the currently detached downstream EPD via the upstream pathway as shown in a next step 851.

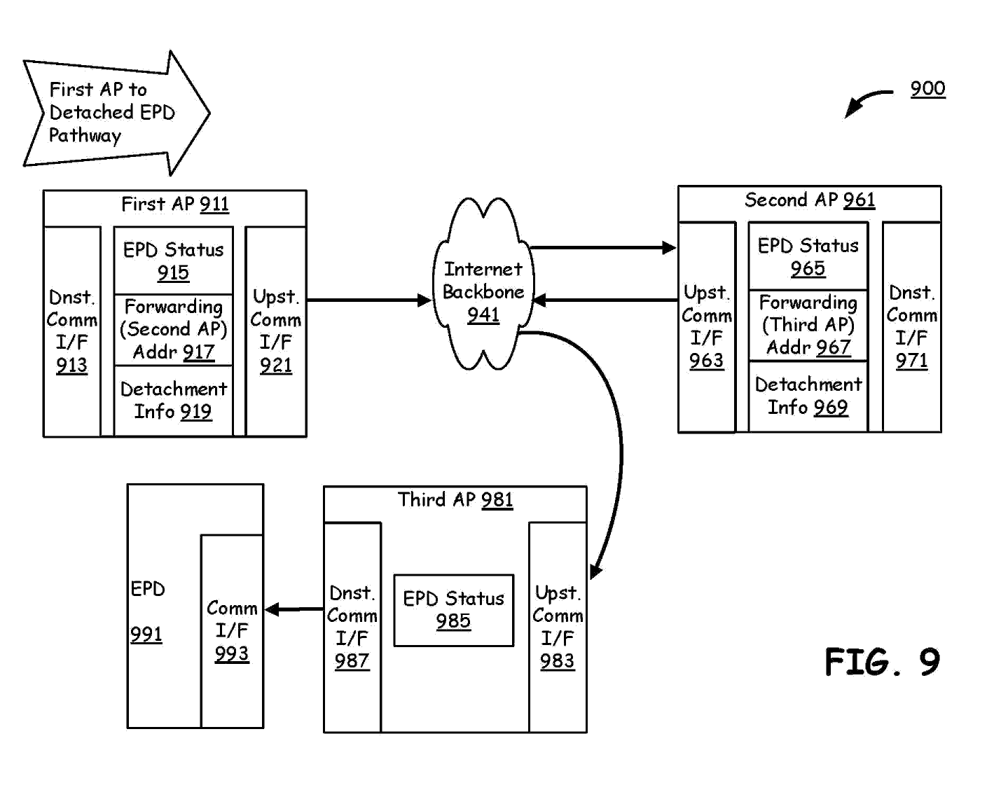

FIG. 9 is a flow chart illustrating a method of delivering data to a detached downstream end-point device 991 by a first access point 911 via an upstream pathway that comprises an Internet backbone 941 and a second access point 961. The first AP 911 belongs to a first data network (not shown here). The second AP 961 belongs to a second data network (not shown here). The first data network and the second data network are operated by different Internet service providers. The first data network and the second data network are coupled to each other via the Internet backbone 941. Hence the first AP 911 and the second AP 961 are communicatively coupled to each other via the Internet backbone 941. The first AP 911 intends to deliver data to the downstream EPD 991. The first AP 911 by using EPD status 915 stored in a memory of the first AP 911 comes to know that the EPD 991 is currently detached from the first AP 911. The first AP 911 sends data to an attached EPD via downstream communication I/F 913. The first AP 911 thus knows that an attempt to send the data to the EPD 991 via the downstream communication I/F 913 will fail. The first AP 911, in pursuant to detachment information 919 stored in the memory of the first AP 911, retrieves a forwarding address 917 stored in the memory of the first AP 911. The first AP 911 acts in pursuant to the detachment information 919 if the first AP 911 intends to communicate with the EPD 991 after detachment. The first AP 911 typically receives the forwarding address 917 from the EPD 991 at an earlier instant of time when the EPD 991 was attached to the first AP 911. The forwarding address 917 typically comprises network address of other AP(s) to which the EPD 991 was attached at the earlier instant of time. By way of example, the forwarding address 917 is network address of the second AP 961. The first AP 911, under the assumption that the detached EPD 991 is currently attached to the second AP 961, sends the data to the Internet backbone 941 via upstream communication I/F 921 using the forwarding address 917 i.e., the network address of the second AP 961.

The data travels via the Internet backbone 941 and the second AP 961 receives the data via upstream communication I/F 963. The second AP 961 using EPD status 965 determines that EPD 991 is currently detached from the second AP 961. The second AP 961, in pursuant to detachment information 969 stored in a memory of the second AP 961, retrieves a forwarding address 967 stored in the memory of the second AP 961. The second AP 961 encapsulates the data received from the Internet backbone 941 with the forwarding address 967 and sends the encapsulated data to the Internet backbone 941 via the upstream communication I/F 963. The forwarding address 967 is network address of a third AP 981. The Internet backbone 941 delivers the encapsulated data to the third AP 981.

The third AP 981 belongs to a third data network (not shown here). The third AP 981 receives the encapsulated data from the Internet backbone via upstream communication I/F 983. The third AP 981 using EPD status 985 stored in a memory of the third AP 981 determines that the EPD 991 is currently attached to the third AP 981. Thee third AP 981 sends the data received from the Internet backbone 941 to the EPD 991 via downstream communication I/F 987. The EPD 991 receives the data from the third AP 981 via communication I/F 993. The data that the first AP 911 intends to send to the currently detached EPD 991 reaches the EPD 991 via an alternate path that comprises the Internet backbone 941 and other data networks (the second data network and the third data network). The detachment information (919 and 969) and the forwarding addresses (917 and 967) available with the first AP 911 and the second AP 961 ensure that the data destined for the currently detached EPD 991 reaches the EPD 991 from the first AP 911 via the alternate path. Each of the first data network, the second data network and the third data network is one of a terrestrial cellular network, fiber optic network, satellite network, cable data network, wireless local area network, wireless metropolitan area network or any of a variety of proprietary or public data network. The data travels through heterogeneous data networks along journey from the first AP 911 to the third AP 981. The data is any of a variety of live and/or archived multimedia information. The third data network is operated by a third Internet service provider. The EPD 991 is one of a computer, notebook, PDA, phone, video game box etc.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention,

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A communication infrastructure having a backbone network, the communication infrastructure comprising:
a first access point that manages a first wireless network and is communicatively coupled to the backbone network;
a second access point that manages a second wireless network and is communicatively coupled to the backbone network;
an end-point device that is communicatively attached to the first access point via a first radio circuitry and additionally communicatively attached to the second access point via a second radio circuitry; and
the end-point device delivering detachment information to the first access point.

2. The communication infrastructure of claim 1, wherein the end-point device delivers the detachment information to the first access point via the first radio circuitry in anticipation of detachment from the first access point.

3. The communication infrastructure of claim 1, wherein the end-point device delivers the detachment information to the first access point via the second radio circuitry and an indirect pathway after detaching from the first access point, the indirect pathway comprising the second access point and the backbone network.

4. The communication infrastructure of claim 1, wherein the first wireless network is communicatively incompatible with the second wireless network.

5. An end-point device in a communication infrastructure having a backbone network, a remote end-point device, a primary communication network that comprises a primary access point and a secondary communication network, the primary communication network, the secondary communication network and the remote end-point device being communicatively coupled to the backbone network, the end-point device comprising:
radio circuitry that communicatively attaches with the primary access point thereby setting up an association of the end-point device with the primary communication network;
processing circuitry that is communicatively coupled to the radio circuitry the processing circuitry sets up a communication session between the end-point device and the remote end-point device via the radio circuitry; and
a detachment manager communicatively coupled with the radio circuitry and the processing circuitry;
the detachment manager directs delivery of detachment information to the primary access point via the radio circuitry to maintain the communication session with the remote end-point device and also to maintain the association with the primary communication network for at least a period of time after the end-point device detaches from the primary access point.

6. The end-point device of claim 5, wherein the detachment manger directs the delivery of the detachment information to the primary access point prior to detachment of the end-point device from the primary access point.

7. The end-point device of claim 5, wherein the detachment manger directs the delivery of the detachment information to the primary access point via the secondary communication network and the backbone network after detachment of the end-point device from the primary access point.

8. The end-point device of claim 5, wherein the detachment information comprises a time duration for which the association of the end-point device with the primary communication network is maintained after the detachment.

9. The end-point device of claim 5, wherein the detachment information comprises at least one network address corresponding to the secondary communication network, the at least one network address is to be used by the primary access point for delivering data to the end-point device via the secondary communication network after the detachment.

10. An access point in a communication infrastructure, the communication infrastructure having a communication network and a destination device, the access point comprising:
upstream communication interface circuitry communicatively coupled to the communication network;
downstream communication interface circuitry communicatively coupled to the destination device; and
a detachment manager communicatively coupled to the upstream communication interface circuitry and to the downstream communication interface circuitry;
the detachment manager receiving detachment information related to the downstream destination device;
the detachment manager operating pursuant to the received detachment information after the downstream destination device detaches from the access point.

11. The access point of claim 10, wherein the detachment manager receives the detachment information via the upstream communication interface.

12. The access point of claim 10, wherein the detachment manager receives the detachment information via the downstream communication interface.

13. The access point of claim 10, wherein the detachment information comprises a detach command from the downstream destination device.

14. The access point of claim 13, wherein the detachment manager operates pursuant to a default logic stored in the access point after receiving the detach command from the downstream destination device.

15. The access point of claim 10, wherein the detachment information comprises network address of a secondary access point; and
the detachment manager directs forwarding of data destined for the downstream destination device to the secondary access point via the upstream communication interface circuitry after the downstream destination device detaches from the access point.

16. A method performed by an end-point device that is running a communication session with a remote end-point device by way of communicatively attaching to a primary access point that belongs to a primary communication network, the method comprising:
sending a detachment information to the primary access point in order to maintain the communication session with the remote end-point device and also to maintain association with the primary communication network for at least a period of time after detaching from the primary access point;
maintaining the communication session with the remote end-point device for the at least a period of time after detaching from the primary, access point; and
maintaining the association with the primary communication network for the at least a period of time after detaching from the primary access point.

17. The method of claim 16, further comprising sending the detachment information to the primary access point via a secondary access point: wherein the end-point device is in addition communicatively attached to the secondary access point that belongs to a secondary communication network.

18. The method of claim 17, wherein the primary communication network and the secondary communication network are communicatively incompatible.

19. A method performed by an access point in a communication infrastructure, the communication infrastructure having a backbone network and an end-point device, the access point is communicatively coupled to the backbone network, the access point manages a first downstream network using a, first protocol, the method comprising:
receiving detachment information related to the downstream end-point device;
determining if the downstream end-point device is detached from the access point; and
operating pursuant to the detachment information after the downstream end-point device detaches from the access point.

20. The method of claim 19, wherein the access point after detaching from the downstream end-point device delivers data destined for the downstream end-point device to the downstream end-point device via the upstream backbone network and a secondary access point to which the downstream end-point device is currently attached, the secondary access point is communicatively coupled to the backbone network and manages a second downstream network using a second protocol.

21. Tile method of claim 20, wherein the first protocol and the second protocol are communicatively incompatible.
